(19) United States
(12) Patent Application Publication
(10) Pub. No.: US 2007/0014105 A1
(43) Pub. Date: Jan. 18, 2007

(54) Indoor/outdoor smart mechanically and electrically rechargeable led lamp with cell phone charger

(75) Inventors: Mei Noguchi, Westfield, NJ (US); Hiro Ogura, Kenilworth, NJ (US); Ming Chun Li, Zhong Shan City (CN)

Correspondence Address: VOLPE AND KOENIG, P.C., UNITED PLAZA, SUITE 1600, 30 SOUTH 17TH STREET, PHILADELPHIA, PA, 19103, US

(73) Assignee: Teledex, Inc., Kenilworth, NJ (US)

(21) Appl. No.: 11/443,716

(22) Filed: May 31, 2006

Related U.S. Application Data
(60) Provisional application No. 60/686,807, filed on Jun. 2, 2005.

(51) Int. Cl. F21L 4/00

(52) U.S. Cl. 362/183; 362/276

(57) ABSTRACT

A compact, battery-operated, rechargeable device providing flashlight and nightlight capabilities responsive to one or both of motion detection and light detection, and which is further capable of providing a timed flashlight operation, all within a highly compact, rugged housing.

### CROSS REFERENCE TO RELATED APPLICATION(S)

This application claims priority from Ser. No. 60/686,807 filed on Jun. 2, 2002, which is incorporated by reference as if fully set forth.

### FIELD OF INVENTION

The present invention relates to portable, battery-operated lights and more particularly to a portable compact device providing a plurality of operating modes for selectively illuminating a flashlight and nightlight and an indicator responsive to the selected operating mode and motion and light detection devices.

### BACKGROUND

Whereas, portable, battery-operated flashlights have the capability of recharging their batteries and nightlights have a capability of being illuminated responsive to a light sensor, present day portable flashlights and/or nightlights lack the capability of providing all of the aforesaid features in one unit and being further combined with an operating mode responsive to detection of motion to provide further safety features.

### SUMMARY

The present invention is characterized by comprising a compact, battery-operated, rechargeable device providing flashlight and nightlight capabilities responsive to one or both of motion detection and light detection, and which is further capable of providing a timed flashlight operation, all within a highly compact, rugged housing.

### BRIEF DESCRIPTION OF THE DRAWING(S)

The present invention will be understood from a consideration of the accompanying description and drawings, in which like elements are designated by like numerals, and wherein:

FIG. 1 is a perspective view of a battery-operated device embodying the principles of the present invention.

FIGS. 1A, 1B, and 1C respectively show front, back and bottom views of the device shown in FIG. 1.

FIGS. 2A-2J show different operating modes of one embodiment of the invention.

FIGS. 3A and 3B collectively comprise a schematic showing a simplified embodiment of the present invention and FIG. 3 shows the manner in which FIGS. 3A and 3B are arranged.

### DETAILED DESCRIPTION OF THE PREFERRED EMBODIMENT(S)

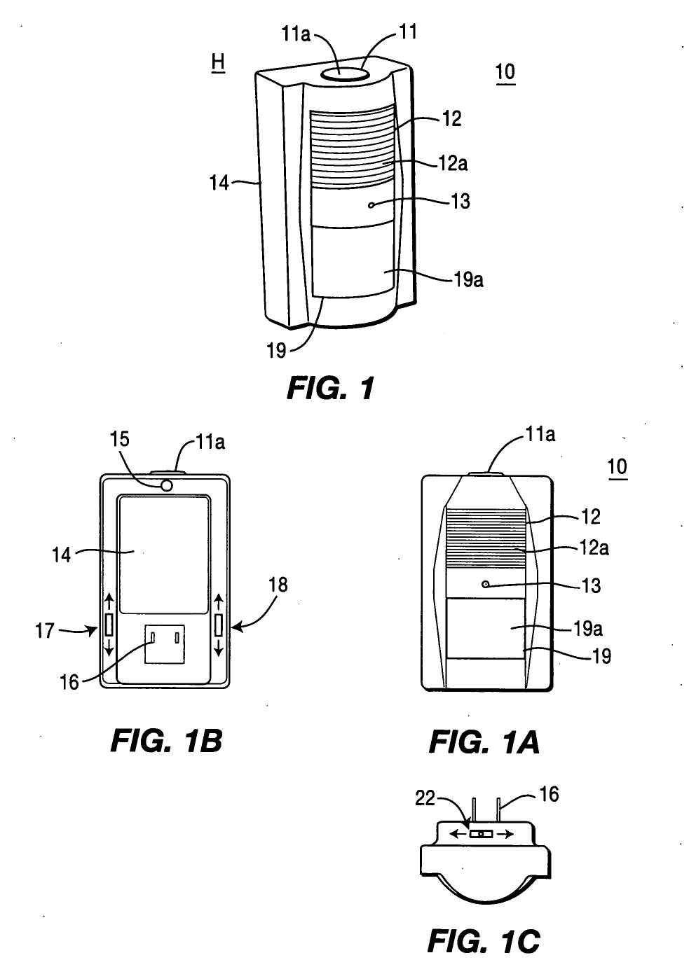

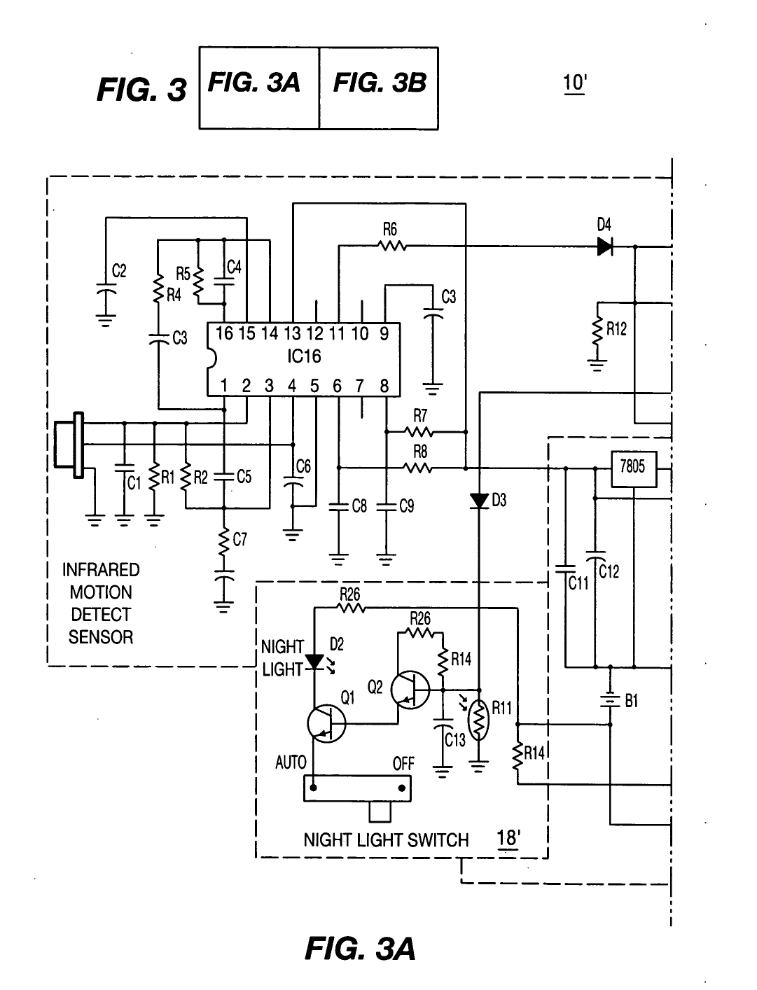

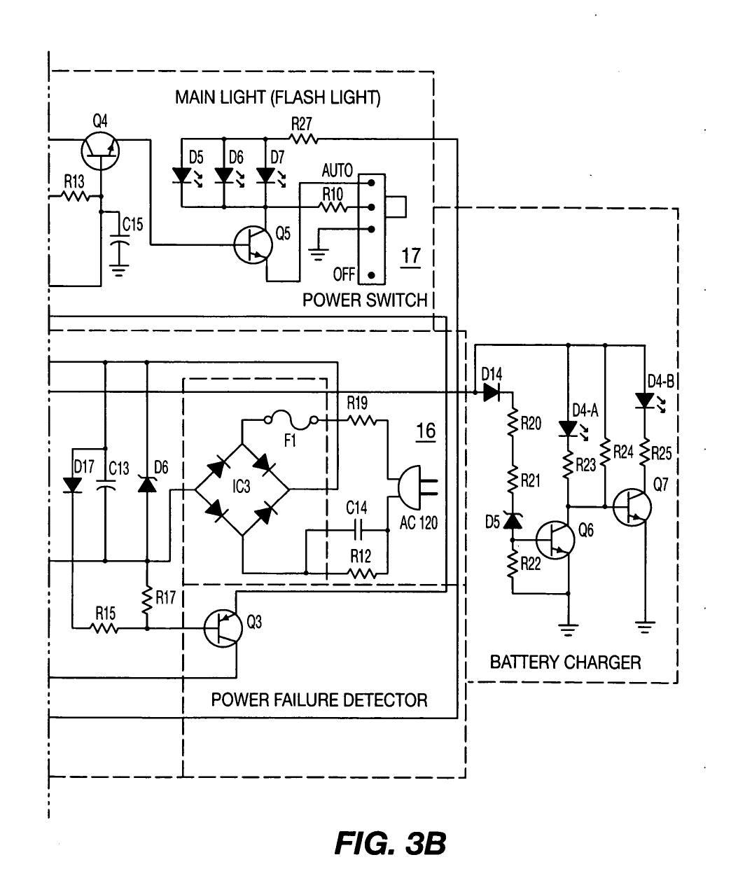

Making reference to FIGS. 1 and 1A-1C, there is shown a device 10 embodying the principles of the present invention and comprising a small, hand-held housing H having an opening 11 at the top end covered with a transparent window 11a for emitting flashlight light and an opening 12 along the front of housing H and covered with a transparent window 12a for emitting light from a nightlight. At least one LED 13 is provided for indicating the state of the battery, as well as other indications. A window 19 having a window 19a, covers the motion sensor RD, to be described below and shown in FIGS. 3A and 3B.

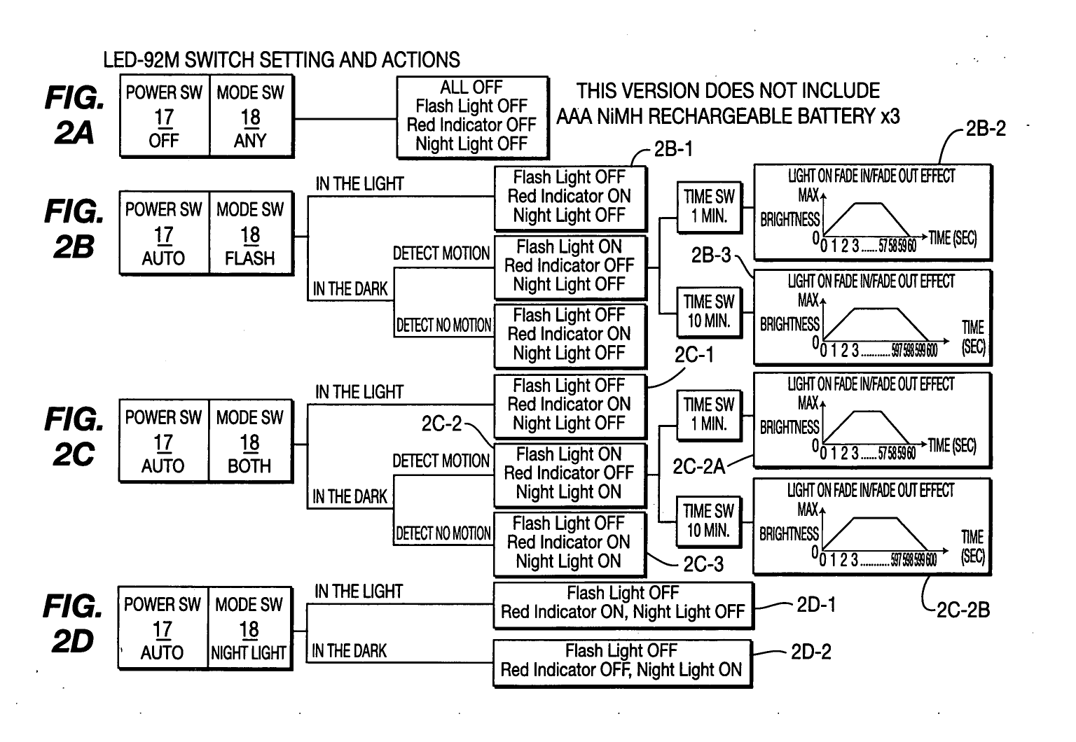

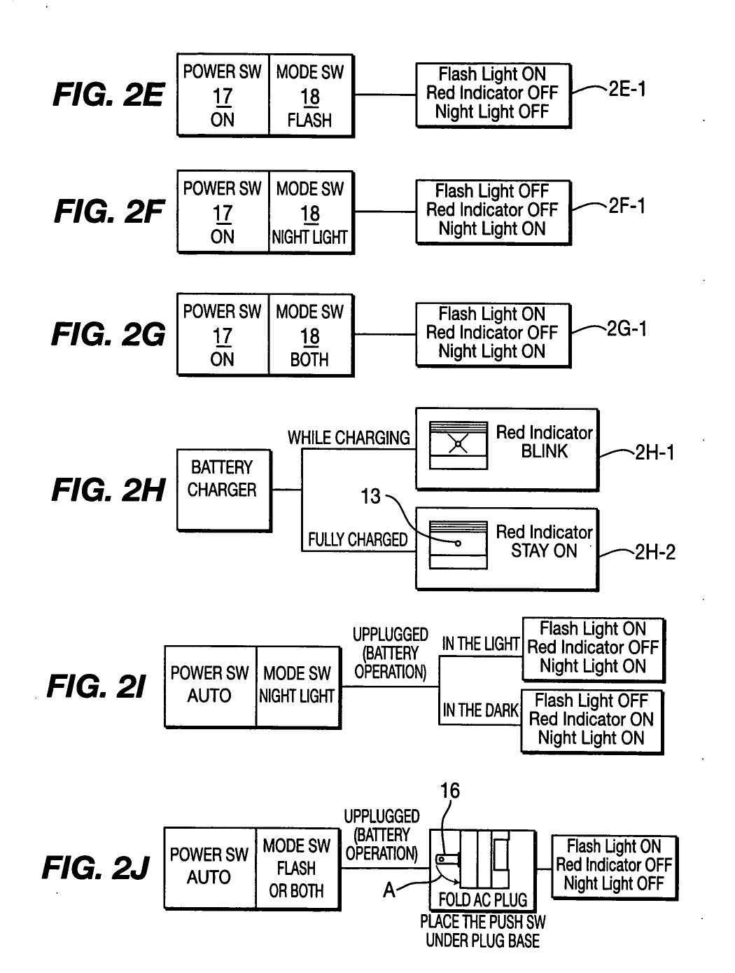

A cover 14 along the rear surface is capable of being opened by operation of a rotatable locking member 15 to gain access to the battery compartment. A swingably mounted electric plug 16 is shown in the position for being plugged into an electrical outlet in FIGS. 1B, 1C and 2J. The plug may be folded down for storage by swinging the plug 16 into the direction of arrow A in FIG. 2J to place the plug in the stored position.

A power switch 17, which is comprised of a slide switch member is capable of being slidably positioned in an OFF, ON or automatic (AUTO) operating position. A mode switch assembly 18, which is likewise a slide switch structure, permits the selection of the modes flash, nightlight or both.

A time switch assembly 22, which is likewise a slide switch structure, is mounted along the bottom surface of the housing H and has a position of either “1” or “10” representing a time interval of either one (1) minute or ten (10) minutes, for a purpose to be described below.

The various operating modes are shown in FIGS. 2A through 2J.

Making reference to FIG. 2A, when the power switch 17 is in the off position, the flashlight, emitted at 11, the red indicator light 13 and the nightlight 12 are off, regardless of the position of the mode switch 18.

Making reference to FIG. 2B, in ambient light, such as daylight or in a lighted room, when the power switch is in the automatic (AUTO) position, and the mode switch is in the flash position, the flashlight is off, the red indicator lamp 13 is on indicating that the batteries are fully charged and the nightlight is off, when the ambient light exceeds a given threshold. Alternatively, when the batteries are charging but are not fully charged, light 13 either flashes on and off or alternatively provides a continuous light of a color different from the color light emitted when the batteries are fully charged. When the light sensor within housing H detects the ambient light as being above the given threshold, such as normal daylight conditions or conditions found in a lighted room, as shown at 2B-1, the flashlight is off.

When the ambient light falls below the given threshold, i.e., when device 10 is “in the dark” and the motion sensor (see FIG. 3) within housing H detects motion, the flashlight is turned on, the red indicator is turned off and the nightlight is turned off. At this time, depending upon the position of the time switch 22, the flashlight is turned on for either one minute or ten minutes as shown at 2B-2 and 2B-3, respectively. When the time switch is in the one-minute position, the flashlight is illuminated in a gradual fashion, requiring approximately three seconds to reach maximum intensity from a fully-off condition. The light output remains at maximum intensity until approximately fifty-seven (57) seconds after first being turned on, and gradually reduces in intensity over the next three seconds until the flashlight is turned off. When the time switch is in the ten-minute position, the fade-in and fade-out portions of lamp illumination are substantially identical to those shown during the one-minute duration except that the flashlight is maintained at maximum intensity for nine (9) minutes and sixty-four (64) seconds, i.e., for the period between the flashlight reaching maximum intensity three seconds after being turned on and gradually starts reducing intensity three seconds before the ten-minute interval expires.

Making reference to 2C, with the power switch 17 in the AUTO mode, and the 18 mode switch in the BOTH mode, the operation in ambient light, i.e., above the ambient light threshold, shown at 2C-1, is identical to the operation shown at 2B-1. When the ambient light falls below the given threshold and motion is detected, the flashlight is turned on, the red indicator 13 is turned off and the nightlight is turned on, as shown at 2C-2, the light staying on either for one minute or ten minutes in accordance with the position of the timing switch 22 as shown at 2C-2A and 2C-2B, which operation is substantially identical to that shown at 2B-2 and 2B-3, except for the fact that the nightlight is also on. When no motion is detected and the ambient light is below the aforementioned predetermined threshold, the flashlight is off, the red indicator 13 is on, and the nightlight remains on, as shown at 2C-3.

Making reference to FIG. 2D, when the power switch is in AUTO, and the mode switch is in NIGHTLIGHT, when ambient light is greater than the predetermined threshold, the flashlight remains off, the red indicator13 remains on and the nightlight remains off as shown at 2D-1. When the ambient light drops below the aforementioned predetermined threshold, the flashlight and red indicator are off, and the nightlight turns on as shown at 2D-2.

Making reference to FIG. 2E, with the power switch in the ON position, and the mode switch in the FLASH position, the flashlight is turned on, the red indicator is turned off, and the nightlight is turned off.

Making reference to FIG. 2F, when the power switch is in the ON position, and the mode switch is in the NIGHTLIGHT position, the flashlight is off, the red indicator is off and the nightlight is on as shown at 2F-1.

Making reference to FIG. 2G, with the power switch and the mode switch respectively in the ON and BOTH position, the flashlight and nightlight are both turned on and the red indicator is off, as shown at 2G-1.

Making reference to FIG. 2H, when the device 10 has its AC plug 16 plugged into an electrical outlet, during charging and before the rechargeable batteries reach a fully charged condition, red indicator 13 blinks, as shown at 2H-1. When the rechargeable batteries are fully charged, the red indicator remains constantly on, as shown at 2H-2.

Making reference to FIG. 2I, with the power switch and mode switch respectively in the AUTO and NIGHTLIGHT position, and assuming that the AC plug 16 has been removed from an electrical outlet, when the ambient light is greater than the aforementioned predetermined threshold, the flashlight, red indicator 13 and nightlight are all off. When ambient light drops below the aforementioned predetermined threshold, the flashlight and red indicator are off while the nightlight is turned on.

Making reference to FIG. 2J, with the power switch in the AUTO mode, and the mode switch in either the FLASH or the BOTH mode position, and the AC plug is removed from an electrical outlet, the flashlight is on while the red indicator 13 and nightlight are off.

FIGS. 3A and 3B show a schematic diagram of another embodiment 10′ of the present invention, in which the time interval switch shown in FIGS. 1C, 2B and 2C is eliminated and only the one (1) minute time interval is utilized and is a permanent default, eliminating the need for the time interval switch 22, as will be described below. FIG. 3 shows the manner in which FIGS. 3A and 3B are arranged to form the schematic diagram. The electronic schematic diagram 10′ of FIGS. 3A-3B functions in the manner substantially as described in connection with FIGS. 2A through 2J, except that the flashlight light has only a one (1) minute light interval time provided as a default condition (i.e., the ten (10) minute time interval is omitted). The motion sensor RD is connected to the main controller IC16, which preferably a model M7612 integrated circuit controller utilizing an analog mixing, digital design which controls the operation of the main flashlight comprised of a plurality of LED's D5-D7 connected in parallel. Their upper terminals are connected in common to resistor R27, whose opposite terminal is coupled to the positive terminal of battery B1 (it should be understood that the rechargeable battery is preferably three (3) such batteries, shown as one battery symbol for simplicity). The opposite terminals of LEDs D5-D7 are coupled in common to the collector of Q5 and one terminal of resistor R10. The motion sensor RD, which is preferably a model RE200B infra-red motion detector, has its D, S and G terminals respectively connected to the terminals 2 and 4 of IC 16 and ground. With the power switch 17 in the AUTO position and the nightlight switch 18′ in the AUTO position, controller IC16 operates transistors Q4 and Q5 to selectively control the main flashlight (LED's D5-D7), and the nightlight (LED D2) to operate in the manner described hereinabove in FIGS. 2B-2D. The light sensor R11 is electrically coupled to the nightlight control circuit transistor Q2, and the main flashlight control transistor Q4 to selectively control operation of the nightlight and main flashlight according to whether the ambient light is above or below the aforementioned given threshold.

The rechargeable batteries of device 10′ schematically represented by the battery symbol B1, are coupled to a charging circuit comprised of the AC plug 16 and a diode bridge IC3, preferably an integrated circuit, which converts the incoming AC to a DC level, for charging the rechargeable batteries, identified by the conventional battery symbol B1. Regulator circuit 7805, which is coupled across the output of diode bridge IC3, provides a regulated, constant level DC output for charging the batteries. When the output of the full-wave diode bridge IC3 falls below a given threshold, a signal is applied through diode D17 to control transistor Q3. One of the LED's D4-A and D4-B provides a blinking red output when the battery is charging, while the other remains constantly illuminated when the rechargeable batteries B1 reach the fully-charged condition. Alternatively D4-B lights in one color when the battery is charging and D-4A lights in another color when the batteries are fully charged.

Transistor Q3 functions as a power failure detector. When the AC power coupled to plug 16 is interrupted, transistor Q3 automatically turns on the main flashlight LEDs D5-D7 through transistors Q4 and Q5, to provide light for such emergency conditions.

The red lamp further serves the function of being illuminated when the power switch 17 is in the automatic condition and the nightlight switch 21 is in the NIGHTLIGHT position, and ambient light is above the aforementioned predetermined threshold, or no motion is detected when the ambient light is below the aforementioned predetermined threshold. The motion detector employed in the present invention, which is preferably a model No. RE200B has a detection radius range of the order of 12 feet from the sensor. When the output of voltage regulator 7805 coupled to diode D14, is greater than the voltage of battery B1, coupled between resistors R20 and R7 Of the battery charger detection circuit, Q6 is turned off enabling R24 to turn Q7 on and thus turning on LED D4-B to provide a “charging” indication. When B1 is sufficiently charged, the voltage level at the base electrode of Q6 turns on Q6, which turns on LED D4-A and turns off Q7 and D4-B. D4-B provides a red light while D4-A provides a green light, indicating that B1 is adequately charged.

When the power switch 17 is in the ON position, LEDs D5-D7 are directly coupled between B1 and ground and are constantly lit, regardless of the position of night light switch 21. LEDs D5-D7 are capable of remaining on for 12 hours between charges. The LEDs and rechargeable batteries last for years without need for replacement and the LEDs run cool, as opposed to regular flashlight bulbs which heat up and also require much more frequent replacement.

With switches 17 and 18′ both in AUTO mode, the controller IC16, which monitors the condition of motion sensor RD, operates LEDs D5-D7 to gradually build to full illumination in approximately three (3) seconds, remain at a constant illumination level for approximately 54 seconds and turn off in a gradual manner over an interval of approximately three (3) seconds before completion of a one (1) minute interval, when RD detects motion within its operating range, which is of the order of 12 feet. The total interval may be modified, if desired, by adjusting the discrete electronic components coupled to IC16.

What is claimed is:

1. A portable device, comprising:
a power source
a main light source;
a nightlight source;
a motion sensor;
a light detector;
a controller for controlling said light sources;
at least one switch for selectively operating the portable device in ON, OFF and automatic modes;
said ON mode bypassing said controller and coupling the power source to said main light source, said automatic mode enabling said controller to activate said flashlight source responsive to sensing of ambient light by said light sensor which is below a given threshold and responsive to said motion sensor detecting motion occurring within a given operating range of said motion sensor.

2. The device of claim 1 further comprising:
a battery charging circuit coupled to an AC plug movable between a folded position stored in a recess in the device and an operating position for coupling to an electrical outlet providing AC power.

3. The device of claim 2 further comprising:
circuit for producing a flashing of a first red lamp to indicate said battery is charging and for causing a second red lamp to be constantly on whereas the batteries are fully charged.

4. The device of claim 1 wherein said controller activates a red lamp when the power switch is in the automatic mode and the sensor detects ambient light below said given threshold.

5. The device of claim 1 wherein said controller activates a red lamp when the power switch is in the automatic mode and the motion sensor does not detect any motion within the operating range.

6. The device of claim 1 wherein said controller, responsive to detection of motion by said motion sensor, operates said flashlight source to gradually illuminate from an off state to a normal intensity over a first given time interval, maintain normal intensity for a second given time interval and gradually reduce intensity from normal intensity to an off condition over a third given time interval.

7. The device of claim 6 wherein said first, second and third time intervals combined are of the order of one minute.

8. The device of claim 6 wherein the first interval is of the order of three seconds.

9. The device of claim 6 wherein the second interval is of the order of three seconds.

10. The device of claim 6 wherein said first, second and third time intervals are of the order of one minute wherein in a first time mode and of the order of ten minutes when in a second time mode.

11. The device of claim 1 wherein the flashlight source comprises at least one LED.

12. The device of claim 1 wherein nightlight source comprises at least one LED.

13. The device of claim 1 wherein the controller activates the nightlight and flashlight when the switch is in the on position and the nightlight is in the on position.

14. The device of claim 1 wherein the controller activates a red lamp wherein the light sensor senses ambient light above said given threshold and no motion is detected by the motion sensor.

15. The device of claim 14 wherein said controller prevents said red lamp from being activated when the device is disconnected from an AC outlet.

16. The device of claim 14 wherein the controller prevents the red lamp, flashlight and nightlight from being turned on when the switch is in the off position.

17. The device of claim 1 wherein said controller activates said second lamp source when the light sensor detects light below said given threshold.

18. The device of claim 1 wherein a plug is swingably mounted to said housing and moveable between a projecting position and a folded position in a recess in said housing.

19. The device of claim 1 further comprising:
a power failure detector for turning on the main light source when the device is coupled to an AC power source for charging the at least one battery and normal operation of the AC power source is interrupted.

20. The device of claim 1 wherein said controller, responsive to detection of motion by said motion sensor, operates said flashlight source to illuminate for a given time interval.

21. A portable light, comprising:
a housing having openings for first and second lamps which respectively provide flashlight light and nightlight light and housing first and second sensors respectively sensing light and motion;
said first lamp comprising at least one LED;
at least one rechargeable battery;
a battery charging circuit;
a motion sensor and a light sensor respectively positioned in said housing to sense motion and ambient light;
a battery compartment for housing said at least one rechargeable battery;
a red lamp coupled to the charging circuit for indicating a condition of said at least one rechargeable battery and flashing during a charging state and being constantly on when in a fully charged state and the portable light is electrically coupled to an AC electrical outlet;
a switch having off, on and automatic positions;
a controller for selectively operating said first lamp responsive to said light and motion detectors when the switch is in said automatic position and being decoupled from said first lamp and said light and motion detectors when the switch is in the on mode, to directly couple the first lamp to said at least one rechargeable battery.

22. The portable light of claim 21, further comprising:
a nightlight switch having an automatic and an off position;
said controller selectively operating said nightlight responsive to said motion and light detectors when the nightlight switch is in the automatic position.
